(19) United States
(12) Patent Application Publication
(10) Pub. No.: US 2022/0174999 A1
(43) Pub. Date: Jun. 9, 2022

(54) IMPROVEMENTS IN OR RELATING TO ORGANIC COMPOUNDS

(71) Applicant: GIVAUDAN SA, Vernier (CH)

(72) Inventors: Cornelis WINKEL, Bussum (NL); Stephan HAIBER, Almere (NL); Michel VAN BUEL, Leusden (NL)

(21) Appl. No.: 17/604,063

(22) PCT Filed: Apr. 30, 2019
(86) PCT No.: PCT/EP2019/061057

§ 371 Date: Oct. 15, 2021

(51) Int. Cl. A23L 27/12; A23C 9/13

(52) U.S. Cl. CPC A23L 27/12; A23C 9/13

(57) ABSTRACT

A method of imparting a fruit flavour to a food or beverage product, the method comprising the step of incorporating into the flavoured product compounds that are perceptually important contributors in the creation of the desirable flavour, wherein those compounds are provided by fermented dairy material, and matter obtained from at least two botanical varieties, wherein at least one variety contains a relative paucity of at least one flavour characteristic compound, and at least one other variety is selected, bred or engineered such that matter obtained from it contains a relative abundance of said at least one flavour characteristic compound.

### FIELD OF THE INVENTION

The present invention is concerned with flavour compositions and to methods of preparing same. The invention is also concerned with methods of using the compositions to impart fruit flavour to food or beverage products, and to the food or beverage products flavoured with said compositions.

### BACKGROUND OF THE INVENTION

State of the art crafted flavour compositions are prepared using a palette of flavour ingredients, which are chemicals of natural origin, or are identical to chemicals found in nature. There are hundreds if not thousands of such ingredients available on the flavourists' palette, and when they are combined in creative ways they can be employed very successfully to create the flavour subtleties so valued by the food and beverage industry.

However, whereas manufacturers of processed foods and beverages have always demanded great tasting crafted flavour compositions from their flavour suppliers, increasingly they expect their suppliers to provide flavours that are compliant with the so-called “clean label” initiative.

The clean label initiative is not concerned with food safety or food quality. Rather, it is a sentiment driven by a consumer need to understand back-of-pack ingredients declarations found on processed foods and beverages. Consumers are becoming more savvy; they are reading ingredients declarations on packaging, and they want to be able to understand and recognize what those ingredients are in plain language. By way of illustration, an ingredient declaration containing the term “Vitamin C” creates a better, cleaner or clearer impression in the minds consumers than “E300” or “ascorbic acid”, even though the terms describe the same ingredient.

The clean label (sometimes also referred to as “clear label”) initiative is complex to navigate because it consists of an unregulated set of ideals, which inherently lacks clarity. However, it is generally understood and accepted that if an ingredient would not typically be found in a kitchen store-cupboard, or it would not generally be recognized by the public at large, or worse, it has a chemical-sounding name, it may not be considered as clean label.

This creates an obvious challenge for the use of chemical-sounding, artificial ingredients such as colours, emulsifiers, preservatives, and the like. However, crafted flavour compositions are also affected by this. More specifically, even though crafted flavours may be prepared from totally natural ingredients drawn from the flavourists' palette, nevertheless it is required that they are specifically listed in back-of-pack ingredient declarations as “flavour”, “flavouring” or some variant thereof. The difficulty with this is that the term “flavour”, “flavouring” or the like, may fall foul of the clean label requirement because the term is not informative of the ingredients contained within it. If consumers cannot understand the term “flavour” they may view it suspiciously as an attempt to conceal unnecessary ingredients.

WO2016/044470 discloses examples of such flavour compositions containing completely natural ingredients comprising mixtures of essential oils extracted from hitherto known but uncommercialized mint cultivars. However, these mint oils are extracts, and because the process of extraction is not deemed to constitute minimal processing, plant extracts are considered to be flavour ingredients for labeling purposes, and not food as such, and any flavour composition containing such extracts would have to be specifically referred to as a flavour, or otherwise reference would have to be made to mint extract, on back of pack ingredients declarations rendering them unsuitable for clean label purposes.

As a result of the clean label initiative, manufacturers of processed food and beverage products are faced with the challenge of coming up with new ways to meet this consumer need, without compromising the quality and flavour of their products.

In principle, formulators could address the clean label issue by preparing flavour compositions composed entirely of foodstuffs. In this manner, if a fruit flavour could, hypothetically, be prepared entirely of fruit, a food or beverage product flavoured with it could contain an ingredient declaration stating that it contains “fruit” rather than it contains “flavour” or an “extract”. Such a declaration would be expected to meet the clean label standard because the term “fruit” is clear and well-recognized by the average consumer.

In fact, real food pieces are already added to certain processed foods. For example, some yoghurts and desserts contain pieces of real fruit. However, it is also a fact that the fruit pieces used in these instances are merely employed for their visual impact and to create the perception of premium quality and/or authenticity, rather than to create flavour as such because the levels of useful fruit aroma compounds contained in known fruit cultivars are simply not high enough for fruit matter, as such, to provide acceptable flavour when used in commercially reasonable amounts in processed foods and beverages. Indeed, fruit flavour preparations that have employed real fruit pieces also contain significant amounts of crafted flavour compositions comprising flavour ingredients, which are substantially responsible for the nuance, richness and character of flavour that the real fruit pieces cannot provide. Accordingly, such flavour compositions, notwithstanding that they contain real fruit, would not conform to the clean label requirement.

Whilst clean label flavoured processed food or beverage products are desirable, the current state of the art cannot provide flavour compositions solely from foodstuffs that have the requisite intensity, richness and complexity of flavour required by customers.

There are possibly many reasons for this, but one reason may reside in the central breeding aims of the plant breeding industry. Taking fruit breeding as an example, fruit varieties have been subjected to selective breeding over many years with the purpose of addressing various attributes including colour, size, texture, shelf-life and yield as the central breeding aims. Unfortunately, although breeding is designed to amplify or suppress particular facets, traits, attributes or properties of fruit varieties, the amplification of volatile aroma chemicals has not been a priority, and indeed, the unintended consequence of the aforementioned central breeding aims has surely been to alter the levels of, or even eradicate, volatile aroma compounds that are necessary contributors to the richness, nuance and intensity characteristic of a particular type of fruit. Indeed, as far as the applicant is aware, with the possible exception of citrus fruits, there are currently no commercially available botanical varieties that can alone be employed to provide an authentic fruit flavour to a processed food or beverage product.

Manufacturers of processed food and beverage products may no longer be able to rely on brand loyalty alone to secure their market positions, as increasingly customers are making their purchasing decisions based on their impressions of what is written on the ingredients declaration of packaged foods and beverages. Choosing the appropriate labelling creates a healthy and positive impression in the minds of consumers and will almost certainly become an important part of branding strategy. Manufacturers recognize the importance of providing consumers with clear and easily understandable information regarding what is contained in their products, particularly if there is a good story to tell.

There remains a need for suppliers of flavours to the processed food and beverage industry to provide novel, great-tasting flavours, but there is also a developing need to provide such flavours and at the same time assist the manufacturers of processed foods and beverages to create cleaner and clearer labels for their products and in doing so, help shape their front-of-pack claims, as well as their back-of-pack ingredients declarations.

### SUMMARY OF THE INVENTION

In addressing the deficiencies of the prior art, the applicant sought to produce flavour compositions that were capable of imparting a fruit flavour to a food or beverage product, which were comparable in quality to those currently crafted fruit flavour compositions prepared by mixing flavour ingredients found on the flavourists' palette, and which would assist food and beverage manufacturers to make cleaner and clearer ingredients declarations on their packaged products.

Unfortunately, the applicant found that this was not possible using matter obtained from single botanical varieties because, owing to breeding practices over generations, no single variety of plant contained a full complement of necessary aroma compounds (that is compounds that are perceptually important contributors in the creation of desirable flavours) in sufficiently high levels to impart desirable flavours to food and beverage products with the requisite intensity and authenticity.

However, the applicant found that by combining matter obtained from multiple botanical varieties purposely selected, bred or engineered, it was possible to create satisfactory flavour compositions that were comparable with flavour compositions obtained by conventional methods.

More particularly, the applicant found that by combining matter obtained from one botanical variety that contained a relative paucity of at least one flavour characteristic compound, with matter obtained from at least one other botanical variety that was bred, selected or engineered to contain a relative abundance of said at least one flavour characteristic compound, it was possible to create a flavour composition that was determinative of a desired fruit flavour profile for a target food or beverage product. Furthermore, considering that the flavour composition contained only matter from botanical varieties, the conditions for clean label status could be observed.

Accordingly, the invention provides in a first aspect a flavour composition comprising matter obtained from at least two botanical varieties, which matter is purposely selected, bred or engineered such that in combination it contains flavour characteristic compounds that together are determinative of a desired fruit flavour.

In a second aspect there is provided a method of preparing the flavour composition comprising the step of combining the matter obtained from at least two botanical varieties, which matter when combined contains flavour characteristic compounds that together are determinative of a desired fruit flavour.

In a third aspect there is provided a food or beverage product comprising the flavour composition defined herein.

In a fourth aspect there is provided a packaged food or beverage product comprising the flavour composition as defined herein, wherein the ingredients declaration associated with the packaging of said product does not contain any reference indicating additive “flavour” or “flavouring” or any equivalent term thereto.

In particular embodiments of any of the aspects of the invention, the flavour composition comprises matter obtained by selecting matter from a first botanical variety that contains a paucity of at least one flavour characteristic compound; and combining it with matter obtained from at least one other botanical variety that is selected, bred or engineered on the basis that it contains a relative abundance of said at least one flavour characteristic compound; the combination being made in a manner such as to provide a flavour composition containing flavour characteristic compounds that together are determinative of a desired fruit flavour for a target food or beverage product.

In particular embodiments of any of the aspects of the invention the varieties are of the same species.

In particular embodiments of any of the aspects of the invention the botanical varieties are fruit varieties from the family Rosaceae, and more particularly still berry varieties, for example strawberry varieties.

Further and more specific objects, features and advantages will clearly appear from the detailed description given below.

### DETAILED DESCRIPTION OF THE INVENTION

With the possible exception of citrus, owing to the breeding practices across generations, it is currently not possible to create flavour compositions that can deliver intense and authentic fruit flavours to food and beverage products using matter obtained from a single botanical variety. The problem of flavouring a food or beverage with matter obtained from a single botanical variety resides in the limited amount of matter that can reasonably be added to a food or beverage product taking product quality and economic considerations into account. For example, it stands to reason that it is impractical or unacceptable to add 150 grams of fruit to 100 grams of yoghurt and still consider the product to be yoghurt.

As summarized hereinabove, the applicant has addressed this deficiency in the prior art and provides flavour compositions, and methods of making them, that contain matter obtained from at least two botanical varieties, wherein the combined matter obtained from these varieties contains a complement of flavour characteristic compounds that together are determinative of a fruit flavour that a formulator is desirous of imparting to a food or beverage product. It is the combination of matter that is important, as matter from a single variety does not provide an acceptable or desirable flavour. The invention is based on the concept that a first botanical variety is bred, selected or engineered such that matter obtained from it has a very high level of (that is, it is enriched in or has an abundance of) one or more flavour characteristic compounds needed to provide a desired fruit flavour, but which contains an insufficient amount of (a paucity of) one or more other flavour characteristic compounds needed to provide the desired fruit flavour; and matter from this first variety is combined with matter obtained from at least one other botanical variety that is bred, selected or engineered to have very high levels of said one or more other flavour characteristic compounds, which are only insufficiently present in, or absent from, matter obtained from said first variety, such that the complement of flavour characteristic compounds contained in the combination of matter is determinative of the desired fruit flavour.

The term “variety” or “varieties” is used in the general sense of a plant grouping within a single botanical taxon, more typically genus or species, which is defined by the reproducible expression of its distinguishing and other genetic characteristics. The term may include both naturally occurring forms, as well as those derived by selection, or intentional or unintentional breeding using conventional methods or genetic engineering, with the object of creating varieties for the industrial production of one or more desired flavour characteristic compounds rather than the production of single varieties that produce fruit that is of suitable quality to be eaten whole. The term includes hybrids and cultivars (cultivated varieties). It may also include, but is not limited to the meaning given to “plant variety” defined by UPOV; “variety” as defined by the ITPGR; or “cultivar” as defined by the ICNCP. For the purpose of the present invention, the botanical variety does not include herbs or spices, such as varieties of mint.

The term “matter” as in “matter obtained from a variety” refers to matter obtained from botanical varieties, including whole fruits of said varieties, or any part thereof obtained by processing. Taking as an example strawberry fruit in particular, “matter” refers to the whole fruit, pieces of whole fruit, or parts of the fruit, such as its pulp, flesh, skin, juice, seeds and the like that is obtained by processing.

The term “processing” generally refers to any minimal process steps that would typically be used in kitchen techniques for the preparation of food that preferably would not result in the production of matter considered to be a flavour ingredient requiring specific labelling as a “flavour”, “flavouring” or such like on an ingredients declaration of a processed food or beverage product according to any prevailing regulation or industry practice. The term “processing” includes, but is not limited to heating, boiling, concentrating, freezing, e.g. freeze-concentrating, drying, filtering, sieving, centrifugation, juicing, cutting, chopping, crushing, grinding, fermenting, or any enzymatic treatment used in the preparation of foods or beverages such as fruit preparations and fruit purees.

Techniques such as fractional distillation, distillation, extraction, e.g. solvent extraction, derivatization or other such processes that would alter the characterization of the matter as natural under relevant legislations, such as labelling legislation, or would require a specific listing on a back-of-pack ingredients declaration that would be inconsistent with clean labelling, are not considered to be techniques commonly used in the preparation of food or beverages and so are not considered to be “processing” as the term is used in the present invention.

The removal of water from botanical, e.g. fruit matter is considered to be “processing” within the terms of the present invention. Furthermore, if during the removal of water any flavour characteristic compounds are lost, for example, through volatilization, then it is also considered to be “processing” to add back any amounts of flavour characteristic compounds lost.

In particular embodiments of the invention, processing as it relates to fruit matter and more particularly strawberry matter, includes the removal of water to provide a concentrate, and the flavour composition according to the invention may be a fruit concentrate, and more particularly a strawberry concentrate.

In embodiments of the present invention, in the preparation of flavour compositions comprising matter obtained from varieties of fruit, such as strawberry, the fruit matter may be processed to remove water, and as such the flavour composition is composed of a fruit concentrate, and more particularly a strawberry concentrate.

Water removal may be undertaken using any techniques known in the art. However, preferably it is carried out by freezing the water out of the fruit material. More particularly, water may be removed by the technique of freeze-concentration. Freeze-concentration is a process whereby the temperature of an aqueous solution is lowered to partially freeze the water in order to create an ice crystal slurry in a dispersed concentrated solution. Applied to the present invention, fruit matter, more particularly strawberry matter, can be phase-separated into an aqueous phase sitting above a solid sediment, and the aqueous phase subjected to freeze-concentration. Once the ice crystals are formed they can be removed before the sediment and concentrated aqueous phase can be mixed to form matter in the form of a fruit concentrate for use in the preparation of flavour compositions.

Freeze-concentration is a particularly useful technique because as crystals of pure water ice are formed, the technique can be used to selectively remove only water from the fruit matter. This can be particularly important if it is desired to create flavour compositions that can be used for clean label products as it is important that the processing technique, save for the removal of water, does not substantially alter the composition of the fruit matter.

In particular embodiments of the invention, it may be desirable to process fruit matter, more particularly strawberry fruit matter, to remove certain substances that can adversely impact the organoleptic properties of the flavour composition. More particularly, it may be desirable to remove carboxylic acids, such as malic acid and citric acid, commonly found in fruit material, and which may become concentrated to organoleptically unacceptable levels, particularly when water is removed.

Accordingly, in an embodiment of the invention fruit matter, and in particular strawberry matter, used in the creation of flavour compositions is subjected to a processing step to reduce carboxylic acid content, and more particularly to reduce malic acid or citric acid content.

In an embodiment of the invention, carboxylic acid levels in the processed fruit matter can be reduced to levels such that the pH of the fruit matter is restored to the pH that is characteristic of the fruit matter before removal of water. In the case of strawberry fruit matter, processing is undertaken to remove carboxylic acids until the pH of the processed matter is restored to a value between about 3 and 4.3.

Applicant found that a particularly preferred method for the reduction of said carboxylic acids was to absorb the acid on food grade resin. Resins with a high affinity for carboxylic acid are particularly preferred, such as the commercially available Lewatit MP 62 BG resin.

The term “flavour characteristic compound(s)” as used herein refers to any volatile or non-volatile compound(s) found in a botanical variety, and more particularly the fruit of a botanical variety, that is a perceptually important contributor to its flavour, and which together with other flavour characteristic compounds contained in other botanical varieties, can provide a flavour composition, which is determinative of a desired fruit flavour useful to flavour a food or beverage product. For the purpose of the present invention, a single botanical variety either does not contain all the flavour characteristic compounds determinative of a desired fruit flavour, or if a single variety does contain a full complement of flavour characteristic compounds, they are not present in sufficient quantities to provide a fruit flavour with the requisite intensity and/or authenticity to be suitable for use in flavouring food or beverage products, and more particularly, clean-label food or beverage products.

The term “flavour characteristic compound(s)” may also include a precursor of a flavour characteristic compound. Precursors are compounds that may not themselves possess an interesting taste or aroma or may not be even volatile, but which release or liberate a desired flavour characteristic compound when the matter in which it is present is consumed or processed, for example by any of the processing methods referred to hereinabove, including heating or enzymatic treatment.

The term “flavour composition” as used in accordance with the present invention refers to a composition formed from matter obtained from at least two botanical varieties, which together contain flavour characteristic compounds that are determinative of a desired fruit flavour. Furthermore, a flavour composition is a composition that is intended to be added to a food or beverage product, for the principal purpose of imparting a desired fruit flavour to the product, and not for the purpose principally of providing nourishment.

Flavour compositions and methods of the present invention are particularly useful in creating flavours intended to be imparted to food or beverage products, and more particularly processed food or beverage products, wherein the flavour intensity and character is influenced by the total content of flavour characteristic compounds. The compositions and methods are particularly useful in the creation of flavour compositions that are determinative of all manner of iconic flavours, including strawberry, but also other fruit flavours, for example raspberry, peach, mango or banana and the like.

Flavour compositions are particularly intended to be used to impart a fruit flavour to a processed food or beverage product, which product itself does not possess a fruit flavour. In this regard, flavour compositions of the present invention are particularly suitable to flavour dairy products, such as milks, e.g. buttermilks and sour milks, creams, desserts, puddings, fermented milk products, such as fermented milk drinks, kefirs, yoghurts and the like.

Flavour compositions that are able to impart strawberry flavour to food and beverage products, particularly dairy food and beverage products, and more particularly still fermented dairy food and beverage products, represent particularly preferred aspects of the present invention.

The provision of strawberry flavour is particularly difficult owing to the sweetness, acidity and complex flavour of the authentic strawberry experience.

However, although strawberry flavour is complex, analytically the perceptually important compounds that are reminiscent of the aroma of authentic strawberry flavour—its so-called flavour characteristic compounds—are known and readily accessible to flavourists, and when constructing a prior art crafted strawberry flavour composition in a classic manner, the flavourist typically would draw on the necessary flavour characteristic compounds from his palette of available ingredients and using his skill and creativity, construct the flavour composition by combining them in the requisite quantities.

When attempting to provide authentic strawberry flavour compositions using only matter obtained from strawberry varieties, however, the applicant found that it was not possible to obtain a rich, nuanced strawberry flavour with the requisite intensity using strawberry matter from any single strawberry variety.

The creation of an acceptable strawberry flavour was not a straightforward matter of incorporating one of the long-established, commercially available ready-to-eat varieties, such as “Elsanta” into a food or beverage product. Although these varieties are considered to be high quality and represent some of the most appealing varieties for the ready-to-eat market, due to current breeding practices they do not contain a full complement of flavour characteristic compounds in sufficiently high quantities in order that they could be added to a food or beverage product at acceptably low levels both for economic reasons and reasons related to the product quality, and still provide the requisite intensity and quality of flavour.

On the other hand, mixing matter obtained from a plurality of strawberry varieties selected, bred or engineered to each contain some, but not necessarily all, of the flavour characteristic compounds determinative of a desired strawberry flavour, it was possible to create nuanced, rich and high intensity flavour compositions that when added to a food or beverage product could deliver an intense and authentic strawberry flavour without the need to employ such large volumes of matter that the quality or cost of the food or beverage was adversely affected.

Strawberry flavour compositions according to the present invention may contain mixtures of the following non-exhaustive list of flavour characteristic compounds found in matter obtained from at least two different strawberry varieties bred, selected or engineered for that purpose: methyl butyrate, ethyl butyrate, methyl 2-methylbutyrate, ethyl 2-methylbutyrate, methyl 3-methylbutyrate, ethyl 3-methylbutyrate, methyl hexanoate, ethyl hexanoate, methyl octanoate, ethyl octanoate, ethyl acetate, butyl acetate, pentyl acetate, isopentyl acetate and hexyl acetate, cis-3-hexenol, cis-3-hexenal, hexanol, hexanal, furalon, mesifurane, methyltetrahydrofuranone, maltol, gamma-decalactone, linalool, methyl anthranilate, ethyl anthranilate, methyl N-methyl anthranilate, methyl N-ethyl anthranilate, methyl epi-jasmonate, methyl dihydrojasmonate, and 2-methylbutyric acid.

Further, there are many glucoside compounds in fruits generally, and strawberry in particular, which can act as precursors for flavour characteristic compounds that are determinative of fruit flavour, and strawberry flavour in particular. They include those glucoside precursors found in fruit varieties and especially strawberry varieties that can be liberated from said varieties by, for example, heating or enzymatic activity.

The flavour characteristic compounds are characteristic of certain flavour vectors or directions, such as fruity, sweet, and the like. More particularly, a strawberry flavour composition may contain one or more of: a fruity flavour characteristic compound; a green flavour characteristic compound; a sweet flavour characteristic compound; a lactone-like flavour characteristic compound; a floral concord grape-like flavour characteristic compound; a sweet body flavour characteristic compound; and optionally a precursor compound of any of the foregoing.

Fruity flavour characteristic compounds may be selected from esters, in particular aliphatic esters, such as methyl butyrate, ethyl butyrate, methyl 2-methylbutyrate, ethyl 2-methylbutyrate, methyl 3-methylbutyrate, ethyl 3-methylbutyrate, methyl hexanoate, ethyl hexanoate, methyl octanoate, ethyl octanoate, ethyl acetate, butyl acetate, pentyl acetate, isopentyl acetate and hexyl acetate.

Green flavour characteristic compounds, may be selected from at least one of cis-3-hexenol/al, or hexanol/al;

Sweet flavour characteristic compounds may be selected from at least one of furalon, mesifurane, methyltetrahydrofuranone, and maltol;

Lactone-like flavour characteristic compounds may be selected from at least one of gamma-decalactone, and other related lactones, such as gamma-octalactone, delta-decalactone, or gamma-dodecalactone.

Floral concord grape-like flavour characteristic compounds may be selected from at least one of (m)ethyl anthranilate, methyl N-(m)ethyl anthranilate, methyl epi-jasmonate, or methyl dihydrojasmonate.

Sweet body flavour characteristic compounds may be selected from at least one of 2-methylbutyric acid and related compounds.

Strawberry varieties that may be employed in the creation of flavour compositions of the present invention may be selected from currently known or commercial varieties, or they may be varieties that are intentionally or unintentionally bred, or selected, or engineered as to be enriched in one or more of the flavour characteristic compounds that contribute to the determination of, that is they are determinative of, the flavour of strawberry, including any of the specific flavour characteristic compounds referred to hereinabove.

Furthermore, those strawberry varieties that are intentionally or unintentionally bred, selected, or engineered as to contain low levels of carboxylic acids, such as malic acid or citric acid, and which are enriched in one or more of the flavour characteristic compounds, will be particularly useful in exercise of the present invention.

Particular strawberry varieties include, but are not limited to Alba, Albion, Alice, Alinta, Allstar, Amelia, Annapolis, Apollo, Archer, Arome, Aromas, Asia, Atlas, Benton, Bogota, Bolero, Bountiful, Brunswick, Cabot, Calypso, Camarosa, Cambridge Favourite, Camino Real, Canoga, Cassandra, Cavendish, Chambly, Chandler, Christine, Clery, Clancy, Darselect, Delia, Delite, Delmarvel, Diamante, Earlibelle, Earliglow, Elegance, El-santa, Elvira, Emily, Eros, Evangeline, Everest, Evie 2, Fenella, Firecracker, Flamenco, Florence, Fort Laramie, Frel (PINK PANDA), Fruitful Summer, Gaviota, Glooscap, Governor Simcoe, Guardian, Hapil, Hecker, Hokowase, Honeoye, Hood, Itasca, Jewel, Judibell, Kent, L'Amour, Loran, Lucy, Mae, Mailing Opal, Mailing Pearl, Marshall, Matis, Mesabi, Midway, Mira, Mohawk, Monterey, Northeaster, Northeastern, Ogallala, Orléans, Oso Grande, Ozark Beauty, Palomar, Pandora, Pegasus, Pelican, Pink Panda, Pinnacle, Polka, Portola, Primetime, Puget Reliance, Puget Summer, Quinault, Rabunda, Rainier, Redchief, Redcrest, Redgauntlet, Redgem, Red Ruby, Rennaissance, Rhapsody, Rosie, Roxana, Royal Sovereign, Sable, Saint Pierre, Sallybright, Samba, San Andreas, Sapphire, Sasha, Scott, Seascape, Seneca, Senga Sengana, Sequoia, Shuksan, Snow White, Sonata, Sophie, Strawberry Festival, Sunrise, Surecrop, Symphony, Tillamook, Titan, Totem, Tribute, Tristar, Valley Red, Variegata, Veestar, Ventana, Viktoriana, Wendy, Winona, and Yamaska.

Strawberry varieties can also be selected from wild species, sub-species, natural hybrids, selections and cultivars, such as Fragaria chiloensis, Fragaria virginiana, Fragaria x ananassa, F. vesca, F. viridis, F. moschata, F. vesca f. alba, F. vesca f. alba ‘South Queen Ferry’, F. vesca ssp. vesca ‘Baikal’, F. vesca ssp. Bracteata, F. vesca ssp. Americana, F. vesca f. semperflorens ‘Red Wonder’, F. vesca f. semperflorens ‘Yellow Wonder’, F. vesca ssp. vesca ‘Island’, F. vesca ssp. vesca ‘Kaiserpfalz Tilleda’, F. vesca ssp. vesca ‘Korsika’, F. vesca ssp. vesca ‘Multiplex’, F. vesca ssp. vesca ‘Weimar’, F. vesca ssp. vesca ‘Boehmen”, F. vesca ssp. vesca ‘Tuechersfeld’, F. vesca ssp. vesca ‘Sud-Oeland’, F. vesca ssp. vesca ‘Großolbersdorf’, F. x ananassa cv. ‘Alba’, F. x ananassa cv. ‘Mara de Bois’, F. x ananassa cv. ‘Mieze Schindler’, F. x ananassa cv. ‘Polka’, and F. x ananassa cv. ‘Elegance’.

Particularly useful varieties include any of the varieties selected from the group consisting of Renaissance; F.moshcata; Sengana; F.virginiana W9; F.moschata “cotta”; Polka; Mieze schindler; F. vesca; Korona; Elegance; Holiday; Snow White; and Kaisers Samling.

Flavour characteristic compounds may be found in matter obtained from combining any varieties known in the art that exhibit the desired aroma characterisitics, more particularly from varieties that exhibit suitably high levels of one or more of the flavour characteristic compounds referred to hereinabove, and particularly any of those selected from Renaissance, F.moshcata, Sengana, F.virginiana W9, F.moshcata “cotta”, Polka, Mieze schindler, F. vesca, Korona, Elegance, Holiday, Snow White and Kaisers Samling.

Additionally, varieties, including any of the varieties referred to hereinabove exhibiting said desirable aroma characteristics, and particularly Renaissance and Polka, can be used as parents to produce new cultivars by crossing techniques known in the art, such as, but not limited to out-crossing, back-crossing, reciprocal crossing or selfing. These cultivars formed by such crossing, or indeed further cultivars produced in succeeding breeding cycles may be used in combination as a source of matter containing flavour characteristic compounds determinative of desired flavours.

The present invention is also concerned with flavour compositions that are able to impart fruit flavour to processed food and beverage products that are characteristic of valuable botanicals, including but not limited to raspberry, mango, peach, pineapple, and banana. However, the present invention is preferably not concerned with flavour compositions that provide a citrus flavour, i.e. a flavour from the genus Citrus, including lemon, orange, lime and grapefruit, or a herb or spice flavour.

Authentic raspberry flavour is provided by a combination of flavour characteristic compounds from a combination matter obtained from at least two different raspberry varieties. Important flavour characteristic compounds include but are not limited to isoamyl acetate, raspberry ketone and alfa-ionone.

Raspberry varieties useful in methods and compositions of the present invention may be selected from currently known or commercial varieties, or they may be varieties that are intentionally or unintentionally bred, selected or engineered as to be enriched in one or more of the flavour characteristic compounds determinative of the flavour of raspberry, including any of the specific flavour characteristic compounds referred to hereinabove.

Raspberry varieties useful in carrying out the present invention include but are not limited to Autumn bliss, Glen prosen, Glen ample and Tulameen Tadmor.

In another particular embodiment of the present invention flavour compositions are provided having flavour profiles that are characteristic of peach.

Typical peach flavour characteristic compounds include but are not limited to gamma-decalactone, gamma-undecalactone, linalool and geraniol.

Peach varieties useful in methods and compositions of the present invention may be selected from currently known or commercial varieties, or they may be varieties that are intentionally or unintentionally bred, selected or engineered as to be enriched in one or more of the flavour characteristic compounds determinative of the flavour of peach, including any of the specific flavour characteristic compounds referred to hereinabove.

Peach varieties useful in carrying out the present invention include but are not limited to redskin, robin, royal hale, cardinal and scarlet lady.

In another particular embodiment of the present invention flavour compositions are provided having flavour profiles that are characteristic of pineapple.

Typical pineapple flavour characteristic compounds include but are not limited to heptyl acetate, allyl hexanoate, 1,3,5-undecatriene, and furalon (4-hydroxy-2,5-dimethyl-3-furanone).

Pineapple varieties useful in methods and compositions of the present invention include but are not limited to smooth cayenne, a bacaxi, queen, and red spanish.

In another particular embodiment of the present invention flavour compositions are provided having flavour profiles that are characteristic of banana.

Typical banana flavour characteristic compounds include but are not limited to amyl acetate, amyl butyrate, and eugenol.

Banana varieties useful in methods and compositions of the present invention may be selected from currently known or commercial varieties, or they may be varieties that are intentionally or unintentionally bred, selected or engineered as to be enriched in one or more of the flavour characteristic compounds determinative of the flavour of banana, including any of the specific flavour characteristic compounds referred to hereinabove.

Banana varieties are derived from Musa acuminata and/or Musa paradisiaca and can have different ploidity. Banana varieties useful in methods and compositions of the present invention include but are not limited to lady finger, grand nain, golden beauty, goldfinger, pisang awak, and kluai lep chang kut.

In another particular embodiment of the present invention flavour compositions are provided having flavour profiles that are characteristic of mango.

Typical mango flavour characteristic compounds include but are not limited to ocimene, cis-3-hexenal and hexenol, myrcene, and gamma-decalactone.

Mango varieties useful in methods and compositions of the present invention may be selected from currently known or commercial varieties, or they may be varieties that are intentionally or unintentionally bred, selected or engineered as to be enriched in one or more of the flavour characteristic compounds determinative of the flavour of mango, including any of the specific flavour characteristic compound referred to hereinabove.

Mango varieties useful in carrying out the present invention include but are not limited to: tommy atkins, keitt, haden, glenn, autulfo, sensation, irwin, and ivory.

The flavour composition of the present invention may consist essentially of the matter obtained from at least two botanical varieties that are selected bred or engineered to provide a complement of flavour characteristic compounds determinative of a desired fruit flavour. The flavour compositions may be comprised of 100 wt % of matter obtained from at least two botanical varieties. Should it be desired or necessary, however, the flavour composition may contain other ingredients or adjuvants that add to the organoleptic properties or the chemical or physical stability of the flavour composition.

A flavour composition according to the present invention may be added to a processed food or beverage product in an amount sufficient to provide it with a desired fruit flavour. The trained flavourist using his skill and knowledge and having regard to the target flavour composition; the target food or beverage product; processing conditions both before and after the flavour composition is mixed with the product; as well as intended storage conditions, will be able to determine the precise amount of flavour composition to be employed using only routine skill and knowledge.

As a generality, however, the level of flavour composition added to a food or beverage product will reside within an interval between about 0.1 to 20 wt %, more particularly 1 to 20 wt %, still more particularly between 2, 3, 4, or 5 and 20 wt %, and more particularly still between 5 and 20 wt % based on the total weight of the flavoured food or beverage product.

Depending on the type of flavour that is desired to be imparted to a food or beverage product, flavour characteristic compounds from matter obtained from the botanical varieties should be present individually at levels residing within the interval of about 0.1 to about 1000 ppm, more particularly 0.1 to 500 ppm, and still more particularly 0.1 to 100 ppm based on the weight of the flavoured food or beverage product. Any of the flavour characteristic compounds referred to specifically herein, if employed in a flavour composition, may be employed in amounts such that they are present in the processed food or beverage product at levels falling within the aforementioned intervals.

Methods of preparing flavour compositions as well as flavoured food or beverage products containing them form additional aspects of the invention.

In a method of preparing a flavour composition, the particular varieties that are employed may be selected from known varieties on the basis that they contain levels of desirable flavour characteristic compounds, such that the combination of matter obtained from the varieties contains a complement of flavour characteristic compounds in sufficiently high quantities that when incorporated into a food or beverage product the complement of flavour characteristic compounds in the flavour composition is determinative of a desired fruit flavour. Alternatively, varieties may be intentionally or unintentionally bred, or they may be engineered, in order that when matter obtained from them is combined, it contains the requisite levels of a complement of flavour characteristic compounds determinative of a desired fruit flavour.

The particular varieties selected, bred or engineered for use in the preparation of a flavour composition according to the present invention may not be particularly pleasant to consume in and of themselves because they may not contain a full complement of desirable flavour characteristic compounds in the required amounts in order that they are pleasant to consume as such. For example, it is contemplated that varieties useful in methods of the present invention may be selected, bred or engineered in order that they are highly enriched in certain flavour characteristic compounds, but may contain a relative paucity, or absence of others.

The technical difficulty of flavouring a food or beverage product using only matter obtained from botanical varieties is overcome by methods of the present invention wherein flavour characteristic compounds determinative of a desired flavour that cannot be provided by a single botanical variety, are provided when matter obtained from at least one variety that may be enriched in certain desired flavour characteristic compounds, but not in others, is combined with matter from at least one other variety that is enriched in certain of said other flavour characteristic compounds, such that the combination of matter contains a complement of flavour characteristic compounds that is determinative of a desired fruit flavour.

In a particular embodiment of the present invention, the method of forming a flavour composition comprises the steps of:—

i) providing matter obtained from at least one botanical variety that contains a relative paucity of one or more flavour characteristic compounds;
ii) providing matter obtained from one or more different botanical varieties that is enriched in said one or more flavour characteristic compounds referred to in i); and
iii) combining matter obtained from the steps i) and ii) in a manner that produces a mixture of flavour characteristic compounds that together are determinative of a desired fruit flavour.

In other aspects of the invention, a method of forming a flavoured food or beverage product is provided by mixing the flavour composition formed according to the steps i) through iii) and adding the matter of step iii) to a food or beverage product in an amount sufficient to provide a desired fruit flavour.

In more particular embodiments of the invention, the food or beverage product that is flavoured by the flavour composition is a product that does not have in itself a fruit flavour, for example a dairy product, such as milks, e.g. buttermilk or sour milk, cream, desserts, puddings, fermented milk foods or beverages, such as keffirs, yoghurts and the like.

In more particular embodiments of the invention, in a method of forming a flavour compositions or flavoured food or beverage products, said at least one botanical variety is a variety of strawberry.

In a still more particular embodiment of the invention, there is provided a method of preparing a strawberry flavour composition, the method comprising the steps of:

i) providing matter obtained from at least one strawberry variety that contains a relative paucity of one or more flavour characteristic compounds selected from the group consisting of:
methyl butyrate, ethyl butyrate, methyl 2-methylbutyrate, ethyl 2-methylbutyrate, methyl 3-methylbutyrate, ethyl 3-methylbutyrate, hexyl acetate, cis-3-hexenol, cis-3-hexenal, trans-2-hexenal, trans-2-hexenol, hexanol, hexanal, furalon, mesifuran, 2-methyltetrahydrofuran-3-one, maltol and related compounds, gamma-decalactone, other lactones (gamma-jasmin lactone, gamma-dodecalactone), linalool and related (nerolidol), methyl anthranilate, ethyl anthranilate, methyl N-methyl anthranilate, methyl N-ethyl anthranilate, methyl epi-jasmonate, methyl dihydrojasmonate, and 2-methylbutyric acid and related (3-methylbutyric acid);
ii) providing matter obtained from at least one strawberry variety different from the one referred to in step i), which contains a relative abundance of at least one flavour characteristic compound referred to in step i) above; and
iii) mixing the matter from i) and ii) to form a strawberry flavour composition, wherein the flavour characteristic compounds in said flavour composition together are determinative of a desired strawberry flavour.

As used herein, the term “relative paucity” refers to an amount of a flavour characteristic compound contained in matter obtained from a single variety which is organoleptically insufficient to provide a desired flavour impression when incorporated into a flavour composition and diluted into a food or beverage product.

By extension, the terms “enriched” or “relative abundance” refers to an amount of the flavour characteristic compound contained in one or more varieties, which is perceivable when incorporated in a flavour composition and diluted into a food or beverage product such that it provides a desired flavour impression.

It will be apparent to the skilled person that the invention is not concerned with the provision of a single botanical variety containing a full complement of all the flavour characteristic compounds necessary to create a flavour composition determinative of any particular desired fruit flavour.

Rather, the invention is concerned with the provision of a kit, or a tool-box, consisting of multiple, that is, at least two, at least three, at least four, at least five, at least six, at least seven, at least eight, at least nine, at least ten or more blocks of matter, each obtained from a single botanical variety. The invention contemplates that each variety that forms the basis of a block of matter produces at least one, but not all, of the flavour characteristic compounds in sufficient quantities necessary to produce a flavour composition, which can be optionally processed according to suitable processing techniques referred to herein, and mixed in appropriate quantities to provide a desired flavour composition. The flavour characteristic compounds that are not present in sufficiently high quantities in any given variety, can be provided in other blocks of matter obtained from other varieties, such that when the different blocks of matter are combined, the entire complement of flavour characteristic compounds are present in sufficient concentration to form a desired flavour composition.

Accordingly, the invention provides in another of its aspects a kit of parts for use in the formation of a flavour composition as defined herein, said kit of parts comprising at least two blocks of matter obtained from botanical varieties, each block containing at least one flavour characteristic compound, but not all of the flavour characteristic compounds in sufficient quantities to be determinative of a desired fruit flavour, but which when mixed together the combined matter comprises all flavour characteristic compounds determinative of the desired fruit flavour.

By way of example, in the case of a strawberry flavour kit or tool box, it may comprise a lactone block providing a particular lactone flavour characteristic compound; a green block providing a particular aldehyde flavour characteristic compound; an floral block, providing a floral flavour characteristic compound; and a fruity block, providing an ester flavour characteristic compound; and a jammy block, providing a furaneol flavour characteristic compound.

Owing to the fact that certain flavour characteristic compounds contained in commercially available strawberry varieties are present in too low concentrations to be useful in the creation of flavour compositions according to the present invention, it is particularly important to make blocks of matter enriched in these compounds using the methods described herein. Exemplary of these particularly important blocks of matter is a fruity ester block comprising the flavour characteristic compounds, such as methyl butyrate or ethyl butyrate; a flowery block comprising flavour characteristic compounds such as linalool or nerolidol; a sweet, jammy block comprising flavour characteristic compounds such as furaneol and mesifurane; and a lactone block comprising flavour characteristic compounds such as gamma-decalactone.

Matter comprising one or more of these particular blocks are particularly useful in the preparation of flavour compositions of the present invention.

Given that each block is created to provide a particular flavour characteristic compound or compounds, and not a full complement determinative of a desired fruit flavour, it is anticipated that the varieties selected, bred, or engineered for the purpose of the present invention would not in themselves be particularly useful or valued as ready to eat varieties, and in fact, they may be particularly unsuitable for the ready to eat market. Indeed, in the creation of flavour compositions of the present invention, particular embodiments employ only matter obtained from varieties that are not, or would not be considered to be, of requisite quality for the ready to eat market.

In the creation of flavour compositions of the present invention, it is not necessary that the blocks of matter used to create a particular fruit flavour should be obtained from varieties of the same species. For example, in the creation of a strawberry flavour, the blocks of matter may be obtained only from strawberry varieties, or one or more blocks may be obtained from a different type of botanical, such as cranberry or apple. Indeed, applicant found that matter obtained from the fruit of varieties of paw paw (Asimina triloba) were particularly high in fruity ester compounds, which could be used to provide flavour characteristic compounds that are those esters described above.

The esters referred to hereinabove, and in particular aliphatic esters, are particularly important compounds in the creation of flavours, and particularly flavours for use in imparting fruit flavour to food and beverage products. Although these esters can be obtained by selection, breeding or engineering varieties for that purpose as described hereinabove, certain food or beverage products are also rich sources of these esters and can also represent sources of them. More particularly, dairy matter, and fermented dairy matter in particular, can be a useful source of these esters, and particularly aliphatic esters. Fermentation of dairy starting materials, including milk, cream or whey can produce high levels of the esters referred to above, and in particular (m)ethyl (methyl) butanoate, (m)ethyl hexanoate, (m)ethyl octanoate, ethyl acetate, (iso)amyl acetate, and butyl acetate.

Accordingly, dairy starting materials can be fermented to form fermented dairy material enriched in one or more of these esters, and the fermented dairy material can be used as a source of esters useful in the creation of flavour compositions suitable for imparting fruit flavour to a food or beverage product, particularly when one or more of the esters is combined with other flavour compounds available to the flavourists from other sources that are perceptually important contributors in the creation of a desirable fruit flavour, and which may be sourced, for example, from matter obtained from one or more botanical varieties, more particularly strawberry varieties, referred to herein.

The use of esters obtained from fermented dairy material in the preparation of flavour compositions suitable for imparting fruit flavour to a food or beverage product, and particularly a fermented food or beverage product, including but not limited to yoghurt, forms another aspect of the invention.

Further aspects of the invention include flavour compositions suitable for imparting fruit flavour to said food or beverage product, wherein the flavour composition comprises (i) fermented dairy material enriched in one or more of these esters, and (ii) other flavour compounds that are perceptually important contributors in the creation of the desirable fruit flavour; food or beverage products flavoured with said flavour compositions; as well as methods of making same.

More specifically, the esters obtained from fermented dairy material represent important flavour characteristic compounds in the preparation of fruit flavour compositions, and particularly strawberry flavour compositions described hereinabove. In particular, although it is stated hereinabove that botanical varieties can provide all flavour characteristic compounds determinative of a desired flavour, in certain methods of imparting a fruit flavour, and more particularly a strawberry flavour, to a food or beverage product, some of the desired flavour characteristic compounds, and in particular some or all of the esters can be provided by fermented dairy material, rather than by botanical varieties selected, bred or engineered for the purpose. This is particularly the case when the food or beverage products to be flavoured are dairy products, and more particularly fermented dairy products, such as yoghurt.

Accordingly, in another aspect of the invention there is provided a method of imparting a fruit flavour to a food or beverage product, the method comprising the step of incorporating into the product, flavour characteristic compounds, wherein the flavour characteristic compounds are provided by:

(i) fermented dairy material, and
(ii) matter obtained from at least two botanical varieties, wherein at least one variety contains a relative paucity of at least one flavour characteristic compound, and at least one other variety is selected, bred or engineered such that matter obtained from it contains a relative abundance of said at least one flavour characteristic compound;
wherein, the flavour characteristic compounds obtained from (i) and (ii) together are determinative of the desired fruit flavour.

In embodiments of the invention, some or all of the flavour characteristic compounds, and in particular the esters, may be present in the food or beverage product itself. That is, the fermented dairy material can be part of the food or beverage product. This is particularly the case if the food or beverage product to be flavoured is a fermented product, such as yoghurt.

Alternatively, or additionally some or all of the flavour characteristic compounds, and particularly the esters, may be prepared in a block of fermented dairy material, which can be added to the food or beverage product as part of the flavour composition.

Thus, the invention is concerned in certain of its embodiments with a method of imparting a fruit flavour, and more particularly a strawberry flavour, to a food or beverage product, more particularly a fermented dairy food or beverage product, and more particularly still a yoghurt, wherein a flavour composition comprises a mixture of both matter obtained from at least two botanical varieties as hereinabove described, and a block of fermented dairy material enriched in ester flavour characteristic compounds, and wherein the matter from the botanical varieties and the block of fermented dairy material are added sequentially, separately or simultaneously to the food or beverage product to impart a desired fruit flavour, more particularly a strawberry flavour, to said product.

Embodiments of the invention are also concerned with flavoured food or beverage products made according to these methods.

Fermentation of dairy products to produce fermented dairy material rich in esters can in principle be carried out using lactic acid bacteria. However, owing to the fact that these bacteria do not possess a particularly active esterase system producing high amounts of aliphatic esters, the use of lactic acid bacteria solely can be employed but is not preferred. Yeasts have a highly active esterase system, but they do not grow well on milk products for lack of lactase activity. Accordingly, in achieving fermented dairy material rich in esters it is preferred to use a yeast in combination with a lactase enzyme or a yeast in combination with a microorganism, such as a lactic acid bacterium that is capable of degrading lactose. Alternatively, or additionally, a glucose source or other acceptable sugar sources for yeast can be added to the yeast to avoid the need for enzymes or microorganisms.

Preferred yeasts may be selected from the Saccharomyces family, for example Saccharomyces cerevisiae.

In a method of imparting a fruit flavour, and in particular a strawberry flavour, to a dairy food or beverage product it is desirable to employ ester flavour character compounds at a level of about 5 to 500 ppm, more particularly 5 to 100 ppm, still more particularly 5 to 50 ppm based on the total weight of said food or beverage product. Fermented dairy material can therefore be produced containing high levels of esters, which can be mixed with and diluted in the food or beverage product in a manner described above to provide a desired ester concentration in the finished food or beverage product. For example, if the esters are provided by a fermented dairy material at a level of 250 ppm in the material, and that material is used at 10% dilution in a food or beverage product, then the food or beverage product will contain at least 25 ppm of ester in the product.

Fermented dairy material made in this way that is enriched in butanoate and hexanoate esters is particular suitable for use in the creation of strawberry or pineapple flavours, whereas fermented dairy material enriched in acetate esters is particularly suitable in the creation of banana flavour. One could also combine different fermented dairy materials to create other fruit flavours.

The present invention comprises a number of advantages and benefits over the state of the art flavour creation techniques, in that it provides a method for creating clean-label flavour compositions that are made of matter obtained from combinations of botanical varieties and optionally fermented dairy material, and which are at least as intense, complex and authentic as those flavours made by current state of the art processes. Still further, the use of fermented dairy material as a source, in particular, of ester flavour characteristic compounds in the manner described above will still allow for clean-label food or beverage products, when those food or beverage products are dairy-based. For example, a strawberry yoghurt that is prepared by flavouring un-flavoured yoghurt with a mixture of fermented dairy material rich in esters and blocks of strawberry matter rich in, for example furaneol, linalool and gamma-decalactone in a ratio such that a desired strawberry flavour is achieved, would benefit from a packaging ingredients declaration stating the presence of only strawberry and yoghurt.

As used herein, the term “clean-label” refers to an initiative that is concerned with the information that should be included in the list of ingredients contained in packaged processed foods and beverages. As this term relates to flavour compositions that are used to flavour processed foods and beverages, it means that a flavour composition is deemed to be clean-label and would not need to be listed as a flavour on labelling or packaging, if it is free of ingredients, that is flavour ingredients, that would not be ordinarily considered to be items of food or beverage by consumers, and consumed as such.

By way of example, although the compound methyl anthranilate is an important aroma compound and is found in strawberries, the compound, isolated from strawberry, would not be consumed as a food as such, and so the use of this compound as such in the preparation of a flavour composition, would require that the flavour composition is specifically labeled as a flavour additive or ingredient. Whereas, on the other hand, if a flavour composition consists of matter obtained from a mixture of strawberry varieties (which are regarded as foods as such) and one variety contains methyl anthranilate, such a flavour composition would be considered to be made from food, e.g. strawberry matter and therefore would not need to be labeled as a flavouring, and be considered clean-label as a result.

Accordingly, the invention provides in another of its aspects a clean label food or beverage product flavoured with a flavour composition as hereinabove described.

In embodiments of the invention there is provided a clean label food or beverage product flavoured with a flavour composition that is a fruit concentrate, and more particularly a strawberry concentrate, as described herein above.

In embodiments of the invention there is provided a clean label food product that is a dairy product, and more particularly a yoghurt product, flavoured with a flavour composition that is a fruit concentrate, and more particularly a strawberry concentrate as described herein above.

It will be understood by those skilled in the art that the flavour compositions of the present invention can be used to benefit a wide variety of food or beverage products, which require complex and authentic flavours. Indeed, it is contemplated that the presently disclosed compositions and methods can be employed in a variety of food and beverage products. The term “food product” is to be interpreted broadly, and includes any food product set forth in 21 CFR 101.12. Non-limiting examples of food products include frozen desserts, yogurts, baked goods, fillings, nutritional drinks, beverages, salad dressing or similar dressing, sauces, icings, puddings and custards, batters, and the like.

There now follows a series of examples that serve to further illustrate the invention. The following examples are given to illustrate preferred embodiments of the invention as it is now preferred to practice it. It will be understood that these examples are illustrative and the invention is not to be considered as restricted thereto except as indicated in the appended claims.

### Example 1

### Creation of a Strawberry Flavoured Yoghurt

Strawberry fruit flavours were prepared by homogenising matter from 5 strawberry varieties using equal measures of strawberry and sugar, and pasteurizing the mixture.

The strawberry fruit flavours contained the following levels of specific ingredients. Matter from Variety 1: 250 ppm of gamma-decalactone; matter from Variety 2: 15 ppm of hexanal; matter from Variety 3: 18 ppm of linalool; matter from Variety 4: 105 ppm ethyl butyrate; and matter from Variety 5: 450 ppm of furaneol.

A mix was prepared that contained 20% of matter from each of the Varieties 1 through 5. This mixture was added to a plain yoghurt at 15% w/w ratio.

This strawberry yoghurt, labelled as yoghurt 1, was evaluated blind by an experienced sensory panel against a supermarket strawberry yoghurt containing 15% of a fruit preparation and natural flavour, labelled as yoghurt 2.

The panel judged yoghurt 1 to be superior to yoghurt 2. They thought yoghurt 1 was more fruity, more full and more fresh in comparison with yoghurt 2.

### Example 1a

The strawberry fruit flavours contained the following levels of specific ingredients.

Matter from Variety 1: 100 ppm of gamma-decalactone; matter from Variety 2: 25 ppm of hexanal; matter from Variety 3: 200 ppm of linalool; matter from Variety 4: 2800 ppm ethyl butyrate; and matter from Variety 5: 650 ppm of furaneol.

A mix was prepared that contained 20% of matter from each of the Varieties 1 through 5. This mixture was added to a plain yoghurt at 10% w/w ratio.

This strawberry yoghurt, labelled as yoghurt 1, was evaluated blind by an experienced sensory panel against a supermarket strawberry yoghurt containing 10% of a fruit preparation and natural flavour, labelled as yoghurt 2.

The panel judged yoghurt 1 to be superior to yoghurt 2. They thought yoghurt 1 was more fruity, more full and more fresh in comparison with yoghurt 2.

### Example 1b

The strawberry fruit flavours contained the following levels of specific ingredients.

Matter from Variety 1: 280 ppm of gamma-decalactone; matter from Variety 2: 20 ppm of linalool; matter from Variety 3: 120 ppm ethyl butyrate; and matter from Variety 4: 520 ppm of furaneol.

A mix was prepared that contained 25% of matter from each of the Varieties 1 through 4. This mixture was added to a plain yoghurt at 10% w/w ratio.

This strawberry yoghurt, labelled as yoghurt 1, was evaluated blind by an experienced sensory panel against a supermarket strawberry yoghurt containing 10% of a fruit preparation and natural flavour, labelled as yoghurt 2.

The panel judged yoghurt 1 to be superior to yoghurt 2. They thought yoghurt 1 was more fruity, more full and more fresh in comparison with yoghurt 2.

### Example 1c

The strawberry fruit flavours contained the following levels of specific ingredients. Matter from Variety 1: 260 ppm of gamma-decalactone; matter from Variety 2: 120 ppm of linalool; matter from Variety 3: 1650 ppm ethyl butyrate.

A mix was prepared that contained 33% of matter from each of the Varieties 1 through 3. This mixture was added to a plain yoghurt at 10% w/w ratio.

This strawberry yoghurt, labelled as yoghurt 1, was evaluated blind by an experienced sensory panel against a supermarket strawberry yoghurt containing 10% of a fruit preparation and natural flavour, labelled as yoghurt 2.

The panel judged yoghurt 1 to be superior to yoghurt 2. They thought yoghurt 1 was more fruity, fuller and fresher in comparison with yoghurt 2.

### Example 1d

The strawberry fruit flavours contained the following levels of specific ingredients. Matter from Variety 1: 200 ppm of gamma-decalactone; matter from Variety 2: 400 ppm of furaneol; matter from Variety 3: 100 ppm ethyl butyrate.

A mix was prepared that contained 33% of matter from each of the Varieties 1 through 3. This mixture was added to a plain yoghurt at 10% w/w ratio.

This strawberry yoghurt, labelled as yoghurt 1, was evaluated blind by an experienced sensory panel against a supermarket strawberry yoghurt containing 10% of a fruit preparation and natural flavour, labelled as yoghurt 2.

The panel judged yoghurt 1 to be superior to yoghurt 2. They thought yoghurt 1 was more fruity, fuller and fresher in comparison with yoghurt 2.

### Example 2

### Creation of a Wild Strawberry Flavour Yoghurt

Strawberry fruit flavours were prepared by homogenising matter from 6 strawberry varieties using equal measures of strawberry and sugar, and pasteurizing the mixture.

The strawberry fruit flavours contained the following levels of specific ingredients. Matter from Variety 1: 250 ppm of gamma-decalactone; matter from Variety 2: 15 ppm of hexanal; matter from Variety 3: 18 ppm of linalool; matter from Variety 4: 100 ppm ethyl butyrate; matter from Variety 5: 450 ppm of furaneol; matter from Variety 6: 15 ppm of methyl anthranilate.

A mix was prepared that contained 16.7% of each fruit preparation. This mixture was added to a plain yoghurt at 15% w/w ratio.

This strawberry yoghurt, labelled as yoghurt 1, was evaluated blind by an experienced sensory panel against a supermarket strawberry yoghurt containing 15% of fruit flavour and natural flavour, labelled as yoghurt 2. The panel judged the yoghurt 1 to be superior to yoghurt 2. They thought yoghurt 1 was more fruity, more full and more fresh in comparison with yoghurt 2.

### Example 3

Creation of a Strawberry Flavoured Yoghurt with Strawberry and Apple

Strawberry fruit flavours were prepared by homogenising matter from 4 strawberry varieties and 1 apple variety using equal measures of strawberry and sugar, and pasteurizing the mixture.

The strawberry fruit flavours contained the following levels of specific ingredients. Matter from Variety 1: 250 ppm of gamma-decalactone; matter from Variety 2: 15 ppm of hexanal; matter from Variety 3: 18 ppm of linalool; matter from apple Variety 1: 100 ppm ethyl butyrate; and matter from strawberry Variety 4: 450 ppm of furaneol.

A mix was prepared that contained 20% of matter from each of the fruit Varieties 1. This mixture was added to a plain yoghurt at 15% w/w ratio.

This strawberry yoghurt, labelled as yoghurt 1, was evaluated blind by an experienced sensory panel against a supermarket strawberry yoghurt containing 10% of a fruit preparation and natural flavour, labelled as yoghurt 2.

The panel judged yoghurt 1 to be superior to yoghurt 2. They thought yoghurt 1 was more fruity, more full and more fresh in comparison with yoghurt 2.

### Example 4

Creation of a Strawberry Flavoured Yoghurt with Strawberry and Peach

Strawberry fruit flavours were prepared by homogenising matter from 4 strawberry varieties and 1 peach variety using equal measures of fruit and sugar, and pasteurizing the mixture.

The strawberry fruit flavours contained the following levels of specific ingredients.

Matter from Peach variety 1: 250 ppm of gamma-decalactone; matter from strawberry Variety 2: 15 ppm of hexanal; matter from Variety 3: 18 ppm of linalool; matter from Variety 4: 100 ppm ethyl butyrate; and matter from Variety 5: 450 ppm of furaneol.

A mix was prepared that contained 20% of matter from each of the Varieties 1 through 5. This mixture was added to a plain yoghurt at 15% w/w ratio.

This strawberry yoghurt, labelled as yoghurt 1, was evaluated blind by an experienced sensory panel against a supermarket strawberry yoghurt containing 10% of a fruit preparation and natural flavour, labelled as yoghurt 2.

The panel judged yoghurt 1 to be superior to yoghurt 2. They thought yoghurt 1 was more fruity, more full and more fresh in comparison with yoghurt 2.

### Example 5

Creation of a Strawberry Flavoured Yoghurt with Strawberry and Pawpaw

Strawberry fruit flavours were prepared by homogenising matter from 4 strawberry varieties and matter from 1 paw paw variety using equal measures of fruit and sugar, and pasteurizing the mixture.

The strawberry fruit flavours contained the following levels of specific ingredients.

Matter from Variety 1: 250 ppm of gamma-decalactone; matter from Variety 2: 15 ppm of hexanal; matter from Variety 3: 18 ppm of linalool; matter from Pawpaw Variety 1: 100 ppm ethyl butyrate; and matter from strawberry Variety 5: 450 ppm of furaneol.

A mix was prepared that contained 20% of matter from each of the fruit Varieties. This mixture was added to a plain yoghurt at 15% w/w ratio.

This strawberry yoghurt, labelled as yoghurt 1, was evaluated blind by an experienced sensory panel against a supermarket strawberry yoghurt containing 10% of a fruit preparation and natural flavour, labelled as yoghurt 2.

The panel judged yoghurt 1 to be superior to yoghurt 2. They thought yoghurt 1 was more fruity, more full and more fresh in comparison with yoghurt 2.

### Example 6

A strawberry-flavoured yoghurt is prepared by mixing:

60% of plain yoghurt
25% of a fermented dairy material containing 40 ppm of esters
5% of a block of strawberry material containing 400 ppm furaneol
5% of a block of strawberry material containing 100 ppm of gamma-decalactone
5% of a block of strawberry material containing 20 ppm linalool

1. A method of imparting a fruit flavour to a food or beverage product, the method comprising the step of incorporating into the product flavour characteristic compounds, wherein the flavour characteristic compounds are provided by:
(i) fermented dairy material, and
(ii) matter obtained from at least two botanical varieties, wherein at least one variety contains a relative paucity of at least one flavour characteristic compound, and at least one other variety is selected, bred or engineered such that matter obtained from it contains a relative abundance of said at least one flavour characteristic compound;
wherein, the flavour characteristic compounds obtained from (i) and (ii) together are determinative of the desired fruit flavour.

2. The method of claim 1, wherein the food or beverage product is a dairy food or beverage product.

3. The method of claim 1, wherein the food or beverage product is a fermented dairy food product.

4. The method of claim 1, wherein the food or beverage product is yoghurt.

5. The method of claim 1, wherein a flavour composition comprising the fermented dairy material and the matter obtained from at least two botanical varieties is added to the food or beverage product.

6. The method of claim 5, wherein the fermented dairy material and the matter obtained from the at least two botanical varieties can be added simultaneously, sequentially or separately to the food or beverage product.

7. The method of claim 1, wherein the flavour characteristic compounds are selected from the group consisting of: esters, including methyl butyrate, ethyl butyrate, methyl 2-methylbutyrate, ethyl 2-methylbutyrate, methyl 3-methylbutyrate, ethyl 3-methylbutyrate, methyl hexanoate, ethyl hexanoate, methyl octanoate, ethyl octanoate, ethyl acetate, butyl acetate, pentyl acetate, isopentyl acetate and hexyl acetate; cis-3-hexenol, cis-3-hexenal, hexanol, hexanal, furalon, mesifurane, methyltetrahydrofuranone, maltol, Gamma-decalactone, linalool, methyl anthranilate, ethyl anthranilate, methyl N-methyl anthranilate, methyl N-ethyl anthranilate, methyl epi-jasmonate, methyl dihydrojasmonate, and 2-methylbutyric acid, precursors of any of the foregoing compounds, and mixtures thereof.

8. The method of claim 7, wherein some or all of the ester flavour characteristic compounds are provided by the fermented dairy material.

9. The method of claim 1, wherein the fruit flavour is strawberry.

10. A flavour composition which imparts a fruit flavour to a food or beverage product, comprising flavour characteristic compounds wherein the flavour characteristic compounds are provided by:
(i) fermented dairy material, and
(ii) matter obtained from at least two botanical varieties, wherein at least one variety contains a relative paucity of at least one flavour characteristic compound, and at least one other variety is selected, bred or engineered such that matter obtained from it contains a relative abundance of said at least one flavour characteristic compound;
and wherein, the flavour characteristic compounds obtained from (i) and (ii) together are determinative of the desired fruit flavour.

11. A food or beverage product flavoured according to to the method of claim 1.

12. The packaged food or beverage product of claim 11, wherein the packaging of said product contains an ingredients declaration that is free of any reference to additive flavour, flavouring or any language equivalent thereto.

13. The packaged food or beverage product of claim 12, wherein the packaged food or beverage product is a dairy food or beverage product.

14. The packaged food or beverage product of claim 12, wherein the packaged food or beverage product is a fermented dairy food product.

15. The packaged food or beverage product of claim 13, wherein the packaged food or beverage product is a yoghurt.

16. The packaged food or beverage product of claim 12, wherein the packaged food or beverage product wherein the desired fruit flavour is strawberry.
